(19) United States
(12) Patent Application Publication
(10) Pub. No.: US 2019/0277067 A1
(43) Pub. Date: Sep. 12, 2019

(54) LIMB ACTIVATED ELECTRIC VEHICLE SUPPLY EQUIPMENT LOCKING SYSTEMS AND METHODS

(71) Applicant: FORD GLOBAL TECHNOLOGIES, LLC, Dearborn, MI (US)

(72) Inventors: Ahthavan Raja Sureshkumar, LaSalle (CA); William Christopher Trego, Royal Oak, MI (US); Gregory Ardisana, Canton, MI (US); Nicholas Tetlow, Plymouth, MI (US); Toussaint Carpenter, Dearborn, MI (US)

(21) Appl. No.: 16/289,695

(22) Filed: Mar. 1, 2019

Related U.S. Application Data
(60) Provisional application No. 62/640,312, filed on Mar. 8, 2018.

(51) Int. Cl. E05B 81/78; H01R 13/639; B60L 53/60; B60L 53/16; H01R 13/621

(52) U.S. Cl. CPC E05B 81/78; H01R 13/6397; B60L 2270/32; B60L 53/16; H01R 13/621; B60L 53/60

(57) ABSTRACT

This disclosure is directed to systems and methods for automatically locking and unlocking electric vehicle supply equipment (EVSE) relative to vehicle inlet assemblies during charging events. A lock may be moved between an engaged position in which a coupler of the EVSE is locked to a charging port and a disengaged positon in which the coupler is unlocked to the charging port. The lock may be moved between the engaged position and the disengaged position in response to a limb of an authorized user being detected within a designated area.

### CROSS-REFERENCE TO RELATED APPLICATIONS

This disclosure claims priority to U.S. Provisional Application No. 62/640,312, which was filed on Mar. 8, 2018 and is incorporated herein by reference.

### TECHNICAL FIELD

This disclosure relates to electrified vehicles, and more particularly to systems and methods for automatically locking and unlocking electric vehicle supply equipment (EVSE) relative to a charging port of a vehicle inlet assembly.

### BACKGROUND

The desire to reduce automotive fuel consumption and emissions has been well documented. Therefore, electrified vehicles are being developed that reduce or completely eliminate reliance on internal combustion engines. In general, electrified vehicles differ from conventional motor vehicles because they are selectively driven by one or more battery powered electric machines. Conventional motor vehicles, by contrast, rely exclusively on the internal combustion engine to propel the vehicle.

A charging system connects an electrified vehicle to an external power source, such as a wall outlet or a charging station, for charging the energy storage devices of the electrified vehicle battery pack. Some charging systems utilize electric vehicle supply equipment (EVSE) that receives electric power from the external power source and transfers the power to the vehicle for charging a battery through a coupler that plugs into a vehicle inlet assembly. The EVSE is a customer owned device and is susceptible to being disconnected or even stolen from the vehicle by unauthorized users during unsupervised charging events.

### SUMMARY

A charging system for an electrified vehicle according to an exemplary aspect of the present disclosure includes, among other things, a vehicle inlet assembly including a charging port, an electric vehicle supply equipment (EVSE) assembly including a coupler configured to plug into the charging port, a lock movable between an engaged position in which the coupler is locked to the charging port and a disengaged positon in which the coupler is unlocked to the charging port, and a control module configured to command the lock between the engaged position and the disengaged position in response to a limb of an authorized user being detected within a designated area.

In a further non-limiting embodiment of the foregoing charging system, the lock includes a solenoid.

In a further non-limiting embodiment of either of the foregoing charging systems, the solenoid is selectively powered by an actuator to move the lock between the engaged position and the disengaged position.

In a further non-limiting embodiment of any of the foregoing charging systems, the lock includes a pin and an aperture.

In a further non-limiting embodiment of any of the foregoing charging systems, the pin is part of the vehicle inlet assembly and the aperture is part of the coupler.

In a further non-limiting embodiment of any of the foregoing charging systems, the pin is part of the coupler and the aperture is part of the vehicle inlet assembly.

In a further non-limiting embodiment of any of the foregoing charging systems, the control module is configured to command movement of the pin into the aperture or out of the aperture in response to the limb being detected within the designated area.

In a further non-limiting embodiment of any of the foregoing charging systems, the designated area includes a peripheral space surrounding the vehicle inlet assembly.

In a further non-limiting embodiment of any of the foregoing charging systems, the designated area includes a peripheral space surrounding the EVSE assembly.

In a further non-limiting embodiment of any of the foregoing charging systems, a sensor system is configured to detect whether the limb is positioned within the designated area.

In a further non-limiting embodiment of any of the foregoing charging systems, the sensor system is configured to authenticate whether the limb detected within the designated area is the limb of the authorized user.

In a further non-limiting embodiment of any of the foregoing charging systems, a sensor system is configured to detect when the coupler is plugged into the charging port.

In a further non-limiting embodiment of any of the foregoing charging systems, the control module is configured to command the lock between the engaged position and the disengaged position in response to receiving each of a user input signal, a user authentication signal, and a plug connection signal from a sensor system.

In a further non-limiting embodiment of any of the foregoing charging systems, the user input signal indicates that the limb has been detected within the designated area, the user authentication signal indicates that the limb is the limb of the authorized user, and the plug connection signal indicates that the coupler has been plugged into the charging port.

In a further non-limiting embodiment of any of the foregoing charging systems, the limb is a foot or a hand of the authorized user.

A method according to another exemplary aspect of the present disclosure includes, among other things, automatically locking or unlocking an electric vehicle supply equipment (EVSE) assembly relative to a vehicle inlet assembly of an electrified vehicle in response to a contactless actuation of a lock by an authorized user of the electrified vehicle.

In a further non-limiting embodiment of the foregoing method, automatically locking the EVSE assembly includes moving a pin of the EVSE assembly or the vehicle inlet assembly into an aperture of the other of the EVSE assembly or the vehicle inlet assembly.

In a further non-limiting embodiment of either of the foregoing methods, the method includes sensing whether a limb is positioned within a designated area relative to the EVSE assembly or the vehicle inlet assembly, determining whether the limb is a limb of the authorized user, and sensing whether a coupler of the EVSE assembly is plugged into a charging port of the vehicle inlet assembly.

In a further non-limiting embodiment of any of the foregoing methods, the method includes automatically locking or unlocking the EVSE assembly in response to sensing the limb within the designated area, determining that the limb is the limb of the authorized user, and sensing that the coupler is connected to the charging port.

In a further non-limiting embodiment of any of the foregoing methods, the contactless actuation includes gesturing a limb of the authorized user within a designated area relative to either the EVSE assembly or the vehicle inlet assembly.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates a powertrain of an electrified vehicle.

FIG. 2 schematically illustrates an electrified vehicle while being charged at a charging station.

FIG. 3 is a highly schematic view of a charging system equipped with a locking mechanism for locking a positioning of an electric vehicle supply equipment (EVSE) assembly when connected to a vehicle inlet assembly.

FIGS. 4A and 4B illustrate exemplary locking mechanisms for locking an EVSE assembly relative to a vehicle inlet assembly.

### DETAILED DESCRIPTION

This disclosure describes systems and methods for automatically locking and unlocking electric vehicle supply equipment (EVSE) relative to vehicle inlet assemblies during charging events. A lock may be moved between an engaged position in which a coupler of the EVSE is locked to a vehicle charging port and a disengaged positon in which the coupler is unlocked relative to the charging port. The lock may be moved between the engaged and disengaged positions in response to a limb of an authorized user being detected within a designated area. These and other features of this disclosure are discussed in greater detail in the following paragraphs of this detailed description.

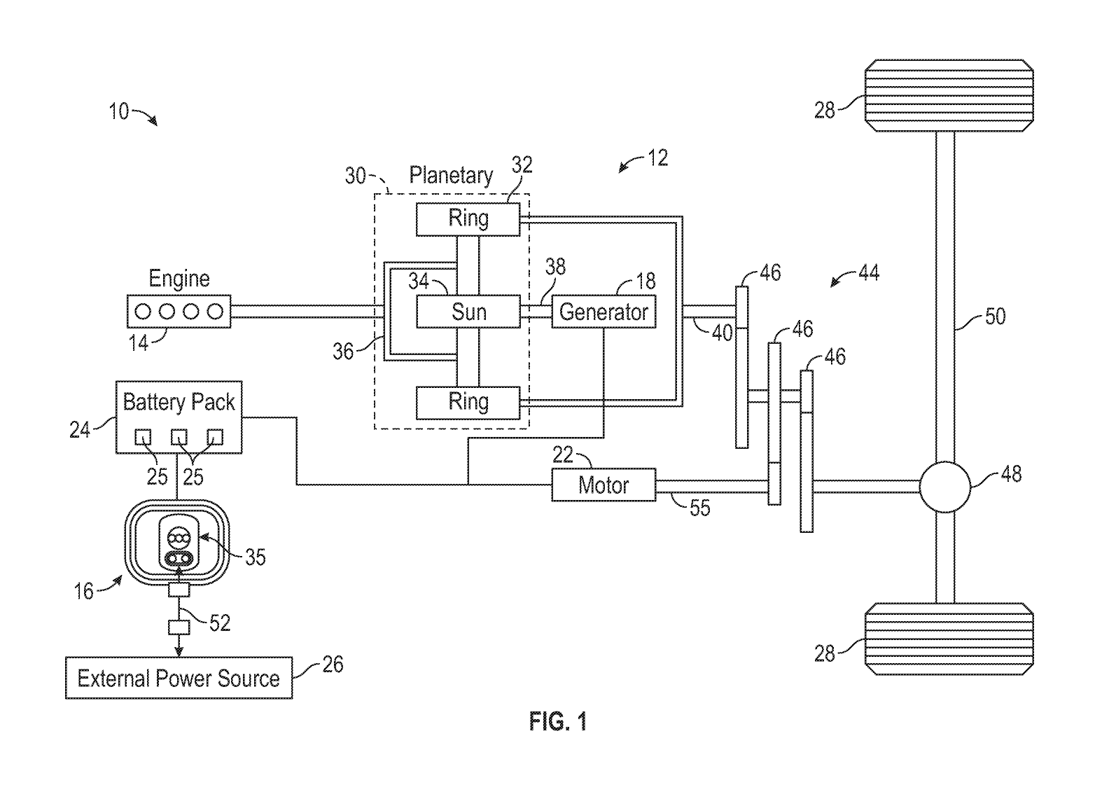

FIG. 1 schematically illustrates a powertrain 10 for an electrified vehicle 12. In an embodiment, the electrified vehicle 12 is a plug-in hybrid electric vehicle (PHEV). In another embodiment, the electrified vehicle is a battery electric vehicle (BEV).

In an embodiment, the powertrain 10 is a power-split powertrain system that employs a first drive system and a second drive system. The first drive system may include a combination of an engine 14 and a generator 18 (i.e., a first electric machine). The second drive system includes at least a motor 22 (i.e., a second electric machine) and a battery pack 24. In this example, the second drive system is considered an electric drive system of the powertrain 10. The first and second drive systems generate torque to drive one or more sets of vehicle drive wheels 28 of the electrified vehicle 12.

The engine 14, which in an embodiment is an internal combustion engine, and the generator 18 may be connected through a power transfer unit 30, such as a planetary gear set. Of course, other types of power transfer units, including other gear sets and transmissions, may be used to connect the engine 14 to the generator 18. In one non-limiting embodiment, the power transfer unit 30 is a planetary gear set that includes a ring gear 32, a sun gear 34, and a carrier assembly 36.

The generator 18 can be driven by the engine 14 through the power transfer unit 30 to convert kinetic energy to electrical energy. The generator 18 can alternatively function as a motor to convert electrical energy into kinetic energy, thereby outputting torque to a shaft 38 connected to the power transfer unit 30. Because the generator 18 is operatively connected to the engine 14, the speed of the engine 14 can be controlled by the generator 18.

The ring gear 32 of the power transfer unit 30 may be connected to a shaft 40, which is connected to vehicle drive wheels 28 through a second power transfer unit 44. The second power transfer unit 44 may include a gear set having a plurality of gears 46. Other power transfer units may also be suitable. The gears 46 transfer torque from the engine 14 to a differential 48 to ultimately provide traction to the vehicle drive wheels 28. The differential 48 may include a plurality of gears that enable the transfer of torque to the vehicle drive wheels 28. In one embodiment, the second power transfer unit 44 is mechanically coupled to an axle 50 through the differential 48 to distribute torque to the vehicle drive wheels 28. In one embodiment, the power transfer units 30, 44 are part of a transaxle 20 of the electrified vehicle 12.

The motor 22 can also be employed to drive the vehicle drive wheels 28 by outputting torque to a shaft 55 that is also connected to the second power transfer unit 44. In one embodiment, the motor 22 is part of a regenerative braking system. For example, the motor 22 can each output electrical power to the battery pack 24.

The battery pack 24 is an exemplary electrified vehicle battery. The battery pack 24 may be a high voltage traction battery pack that includes a plurality of battery assemblies 25 (i.e., battery arrays or groupings of battery cells) capable of outputting electrical power to operate the motor 22, the generator 18, and/or other electrical loads of the electrified vehicle 12. Other types of energy storage devices and/or output devices can also be used to electrically power the electrified vehicle 12.

The electrified vehicle 12 may employ two basic operating modes. The electrified vehicle 12 may operate in an Electric Vehicle (EV) mode where the motor 22 is used (generally without assistance from the engine 14) for vehicle propulsion, thereby depleting the battery pack 24 state of charge up to its maximum allowable discharging rate under certain driving patterns/cycles. The EV mode is an example of a charge depleting mode of operation for the electrified vehicle 12. During EV mode, the state of charge of the battery pack 24 may increase in some circumstances, for example due to a period of regenerative braking. The engine 14 is generally OFF under a default EV mode but could be operated as necessary based on a vehicle system state or as permitted by the operator.

The electrified vehicle 12 may additionally operate in a Hybrid (HEV) mode in which the engine 14 and the motor 22 are both used for vehicle propulsion. The HEV mode is an example of a charge sustaining mode of operation for the electrified vehicle 12. During the HEV mode, the electrified vehicle 12 may reduce the motor 22 propulsion usage in order to maintain the state of charge of the battery pack 24 at a constant or approximately constant level by increasing the engine 14 propulsion. The electrified vehicle 12 may be operated in other operating modes in addition to the EV and HEV modes within the scope of this disclosure.

The electrified vehicle 12 is also equipped with a charging system 16 for charging the energy storage devices (e.g., battery cells) of the battery pack 24. As described in greater detail below, the charging system 16 may include charging components that are located both onboard the electrified vehicle 12 and external to the electrified vehicle 12. The charging system 16 is connectable to an external power source 26 (e.g., utility/grid power from an electrical grid) for receiving and distributing power throughout the electrified vehicle 12.

In an embodiment, the charging system 16 includes a vehicle inlet assembly 35 located on-board the electrified vehicle 12, and an electric vehicle supply equipment (EVSE) assembly 52 that can be operably connected between the vehicle inlet assembly 35 and the external power source 26. The vehicle inlet assembly 35 may include one or more ports adapted to receive a coupler of the EVSE assembly 52. The vehicle inlet assembly 35 is therefore configured to receive power from the external power source 26 and then supply the power to the battery pack 24 for charging the battery cells contained therein.

The charging system 16 may be equipped with power electronics for converting AC power received from the external power source 26 to DC power for charging the energy storage devices of the battery pack 24. The charging system 16 is also configured to accommodate one or more conventional voltage sources from the external power source 26 (e.g., 110 volt, 220 volt, etc.). The charging system 16 may be configured to provide any level of charging (e.g., level 1, 2, DC, etc.).

The powertrain 10 of FIG. 1 is highly schematic and is not intended to limit this disclosure. Various additional components could alternatively or additionally be employed by the powertrain 10 within the scope of this disclosure.

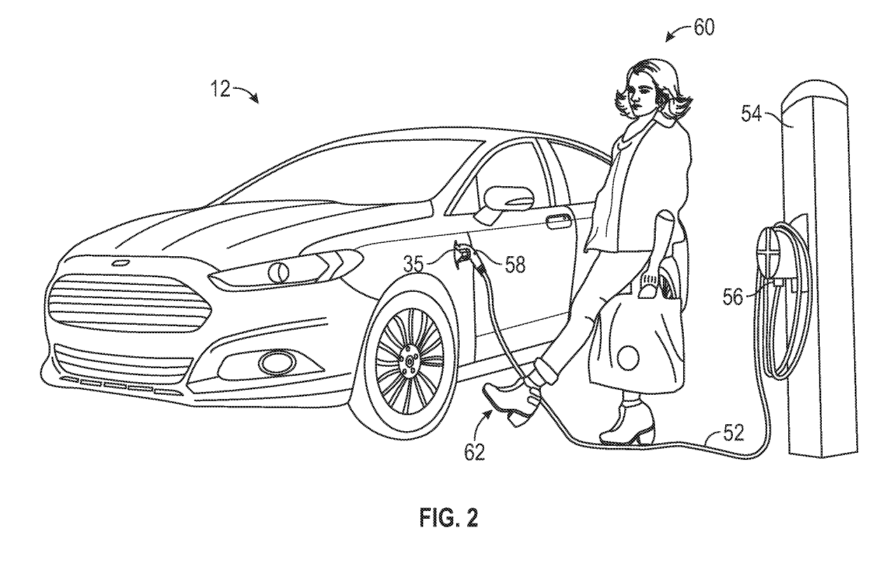

FIG. 2 schematically illustrates an electrified vehicle 12 parked near a charging station 54 for charging. The electrified vehicle 12 may employ the powertrain 10 of FIG. 1, or any other electrified powertrain in which electric drive components are configured to electrically propel the wheels of the electrified vehicle 12 with or without the assistance of an engine.

The charging station 54 is powered by the external power source 26. In an embodiment, the external power source 26 includes utility grid power. In another embodiment, the external power source 26 includes an alternative energy source, such as solar power, wind power, etc. In yet another embodiment, the external power source 26 includes a combination of utility grid power and alternative energy sources.

The EVSE assembly 52 (or a connected cord set of the charging station 54) may be connected to both the charging station 54 (or a wall outlet) and the vehicle inlet assembly 35 for charging the electrified vehicle 12. For example, the EVSE assembly 52 may include a plug 56 for connecting to the charging station 54 (or a wall outlet) and a coupler 58 (sometimes referred to as a connector) for connecting to the vehicle inlet assembly 35 of the electrified vehicle 12. Power originating from the external power source 26 may be transferred from the charging station 54 to the vehicle inlet assembly 35 for charging the battery pack 24 of the electrified vehicle 12 via the coupler 58. The power received by the vehicle inlet assembly 35 may be transferred over high voltage cables to the battery pack 24 for replenishing the energy of the battery cells housed inside the battery pack 24.

In some instances, a user 60 may desire to venture away from the electrified vehicle 12 during the charging event, thereby leaving the EVSE assembly 52 unsupervised. During the absence of the user 60, an unauthorized user could approach the electrified vehicle 12 and attempt to either unplug or steal the EVSE assembly 52. The charging system 16 may therefore be configured to lock the EVSE assembly 52 to prevent its removal from the vehicle inlet assembly 35 of the electrified vehicle 12 during certain situations. As discussed in greater detail below, one or more locking mechanisms of the charging system 16 may be controlled to automatically engage or disengage the EVSE assembly 52 in response to detecting a limb 62, such as a foot or a hand, of the user 60 in relative proximity to the electrified vehicle 12.

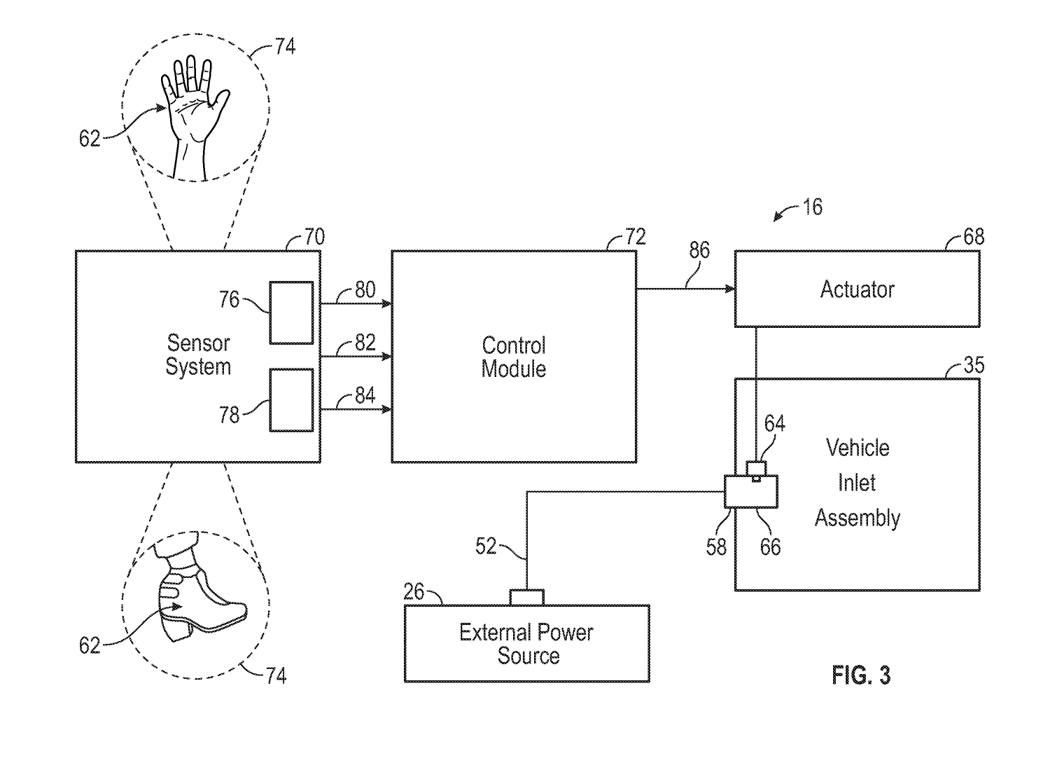

FIG. 3, with continued reference to FIGS. 1-2, schematically illustrates an exemplary charging system 16 of the electrified vehicle 12. In an embodiment, the charging system 16 includes a lock 64 for selectively locking a positioning of the coupler 58 of the EVSE assembly 52 relative to a charging port 66 of the vehicle inlet assembly 35. The lock 64 may be moved between engaged and disengaged positions by an actuator 68. In the engaged position, the EVSE assembly 52 is locked relative to the charging port 66, and in the disengaged position, the EVSE assembly 52 is unlocked relative to the charging port 66. Locking the coupler 58 can prevent theft of the EVSE assembly 52 or an undesired stoppage of a charging event.

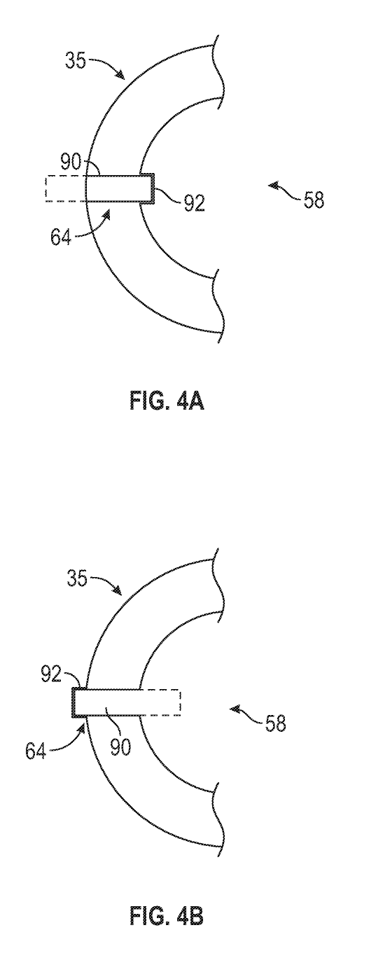

The exemplary lock 64 may include a solenoid that is activated to transition the lock 64 between the engaged and disengaged positions. In a first embodiment, activating the solenoid of the lock 64 could, for example, cause a pin 90 of the vehicle inlet assembly 35 to be inserted into a corresponding aperture 92 of the coupler 58 to lock the coupler 58 in the engaged position (see, e.g., FIG. 4A). In a second embodiment, activating the solenoid of the lock 64 could, for example, cause a pin 90 of the coupler 58 to be inserted into a corresponding aperture 92 of the vehicle inlet assembly 35 to lock the coupler 58 in the engaged position (see, e.g., FIG. 4B). Deactivating the solenoid transitions the lock 64 to the disengaged position, whereby the pin 90 is withdrawn from the aperture 92 to permit the detachment of the coupler 58 from the charging port 66 of the vehicle inlet assembly 35.

This disclosure is not limited to the use of a solenoid as the lock 64. Many other types of locks could be used to selectively hold the coupler 58 in the engaged position, including but not limited to ring clamps, magnets, or vacuum systems.

The charging system 16 may additionally include a sensor system 70 and a control module 72 that may cooperate to determine when to move the lock 64 between the engaged and disengaged positions for locking the coupler 58 in place. In an embodiment, the control module 72 commands the engagement or disengagement of the lock 64 in response to both a user input and an authentication of the user input. The user 60 may initiate the user input via a contactless actuation. For example, in an embodiment, the user input is received in response to the user 60 waving, moving, or otherwise gesturing their limb 62, such as a foot or hand, within a designated area 74, or by moving their limb 62 in a predefined motion pattern. In a first embodiment, the designated area 74 may be located within the peripheral space surrounding the vehicle inlet assembly 35, including the ground surface upon which the electrified vehicle 12 is parked. In a second embodiment, the designated area 74 may be located within a peripheral space surrounding any portion of the EVSE assembly 52. The designated area 74 may be predefined at various other areas relative to the electrified vehicle 12, the charging station 54, or both.

The sensor system 70 may be adapted to sense the user input and to authenticate the user input. For example, the sensor system 70 may sense the connection status of the EVSE assembly 52, whether a user's limb 62 is located within the designated area 74, and whether the user 60 is an authorized user that is near (i.e., within a predefined range of) the vehicle inlet assembly 35, the EVSE assembly 52, or the charging station 54. The sensor system 70 may include various sensors for making these determinations. For example, a connection sensor 76 may be configured for detecting whether the coupler 58 is plugged into the charging port 66, and one or more proximity sensors 78 may be positioned on the electrified vehicle 12, the EVSE assembly 52, and/or the charging station 54 for detecting whether the user's limb 62 is located within the designated area 74 and whether a keyfob or other personal electronic device (e.g., phone) of an authorized user of the electrified vehicle 12 is near the electrified vehicle 12, the EVSE assembly 52, and/or the charging station 54. The proximity sensors 78 may be capacitive, ultrasonic, magnetic, weight, lidar, infrared, induction, radar, or any other type of sensors or combination of sensors.

The control module 72 may be programed or otherwise adapted to control the various functions of the charging system 16. Although shown as a single control module, the control module 72 could be multiple modules that are located on the electrified vehicle 12, the EVSE assembly 52, and/or the charging station 54. The multiple control modules could communicate with one another over data ports.

In an embodiment, among other hardware, the control module 72 includes a processing unit and non-transitory memory for executing the various control strategies of the charging system 16. The control module 72 may receive and process various inputs for controlling the charging system 16, and more particularly, for controlling the lock 64. A first input to the control module 72 may include a user input signal 80 received in response to detecting the presence of the limb 62 within the designated area 74. The user input signal 80 indicates that the user 60 wishes to lock or unlock the coupler 58.

In response to receiving the user input signal 80, the control module 72 may determine whether the user input was initiated by an authorized user. For example, the control module 72 may determine whether a user authentication signal 82 has been received from the sensor system 70. The user authentication signal 82 indicates that the sensor system 70 has detected an authorized user near the vehicle inlet assembly 35, the EVSE assembly 52, or the charging station 54.

A third input to the control module 72 may include a plug connection signal 84 from the sensor system 70. The plug connection signal 84 indicates that the coupler 58 has been plugged into the charging port 66. In response to receiving each of the signals 80, 82, and 84, the control module 72 may communicate a command signal 86 to the actuator 68 for either engaging or disengaging the lock 64. Whether or not the lock 64 is engaged or disengaged will depend on what position the lock 64 is in immediately before the signals 80, 82, and 84 are received by the control module 72.

The charging systems of this disclosure provide for contactless actuation of an EVSE/cord set locking mechanism By taking advantage of limb-activated, contactless controls, for example, the vehicle inlet assembly will not need additional space for accommodating hand-manipulated controls. Moreover, authorized users can interact with the vehicle to either engage or disengage the charging locking mechanism while simply standing next to the vehicle inlet assembly, EVSE, or charging station.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A charging system for an electrified vehicle, comprising:
a vehicle inlet assembly including a charging port;
an electric vehicle supply equipment (EVSE) assembly including a coupler configured to plug into the charging port;
a lock movable between an engaged position in which the coupler is locked to the charging port and a disengaged positon in which the coupler is unlocked to the charging port; and
a control module configured to command the lock between the engaged position and the disengaged position in response to a limb of an authorized user being detected within a designated area.

2. The charging system as recited in claim 1, wherein the lock includes a solenoid.

3. The charging system as recited in claim 2, wherein the solenoid is selectively powered by an actuator to move the lock between the engaged position and the disengaged position.

4. The charging system as recited in claim 1, wherein the lock includes a pin and an aperture.

5. The charging system as recited in claim 4, wherein the pin is part of the vehicle inlet assembly and the aperture is part of the coupler.

6. The charging system as recited in claim 4, wherein the pin is part of the coupler and the aperture is part of the vehicle inlet assembly.

7. The charging system as recited in claim 4, wherein the control module is configured to command movement of the pin into the aperture or out of the aperture in response to the limb being detected within the designated area.

8. The charging system as recited in claim 1, wherein the designated area includes a peripheral space surrounding the vehicle inlet assembly.

9. The charging system as recited in claim 1, wherein the designated area includes a peripheral space surrounding the EVSE assembly.

10. The charging system as recited in claim 1, comprising a sensor system configured to detect whether the limb is positioned within the designated area.

11. The charging system as recited in claim 10, wherein the sensor system is configured to authenticate whether the limb detected within the designated area is the limb of the authorized user.

12. The charging system as recited in claim 1, comprising a sensor system configured to detect when the coupler is plugged into the charging port.

13. The charging system as recited in claim 1, wherein the control module is configured to command the lock between the engaged position and the disengaged position in response to receiving each of a user input signal, a user authentication signal, and a plug connection signal from a sensor system.

14. The charging system as recited in claim 13, wherein the user input signal indicates that the limb has been detected within the designated area, the user authentication signal indicates that the limb is the limb of the authorized user, and the plug connection signal indicates that the coupler has been plugged into the charging port.

15. The charging system as recited in claim 1, wherein the limb is a foot or a hand of the authorized user.

16. A method, comprising:
automatically locking or unlocking an electric vehicle supply equipment (EVSE) assembly relative to a vehicle inlet assembly of an electrified vehicle in response to a contactless actuation of a lock by an authorized user of the electrified vehicle.

17. The method as recited in claim 16, wherein automatically locking the EVSE assembly includes moving a pin of the EVSE assembly or the vehicle inlet assembly into an aperture of the other of the EVSE assembly or the vehicle inlet assembly.

18. The method as recited in claim 16, comprising:
sensing whether a limb is positioned within a designated area relative to the EVSE assembly or the vehicle inlet assembly;
determining whether the limb is a limb of the authorized user; and
sensing whether a coupler of the EVSE assembly is plugged into a charging port of the vehicle inlet assembly.

19. The method as recited in claim 18, comprising:
automatically locking or unlocking the EVSE assembly in response to sensing the limb within the designated area, determining that the limb is the limb of the authorized user, and sensing that the coupler is connected to the charging port.

20. The method as recited in claim 16, wherein the contactless actuation includes gesturing a limb of the authorized user within a designated area relative to either the EVSE assembly or the vehicle inlet assembly.
